(19) United States
(12) Patent Application Publication
(10) Pub. No.: US 2021/0224718 A1
(43) Pub. Date: Jul. 22, 2021

(54) CHAT-BASED TASK MANAGEMENT SYSTEM

(71) Applicant: CUEWORKS, INC., TOKYO (JP)

(72) Inventors: YASUROU NISHIMURA, TOKYO (JP); SEIICHI OKURA, TOKYO (JP); HIROYUKI MUKUNO, TOKYO (JP); AOI SHIRAISHI, TOKYO (JP)

(21) Appl. No.: 16/310,901

(22) PCT Filed: Nov. 15, 2017
(86) PCT No.: PCT/JP2017/041139

§ 371 Date: Dec. 18, 2018

(30) Foreign Application Priority Data
Oct. 13, 2017 (JP) 2017-199889

(51) Int. Cl. G06Q 10/06; H04M 1/7243

(52) U.S. Cl. CPC G06Q 10/063114; H04M 1/7243; H04W 88/02; G06Q 10/063112; G06Q 10/06398; G06Q 10/06316

(57) ABSTRACT

A chat system in which each task is represented as a discrete “task cue” and staff members can share information of task cues being undertaken, handled and completed and also in which a chat function is provided which allows staff members to exchange information regarding each task cue. Such a system enables to explicitly convey information as to the assignment, current status, completion, etc. of the task cues and to promote cooperation among the staff members.

### TECHNICAL FIELD

The present invention relates to a system which enable to manages tasks handled by multiple users using mobile terminals having wireless communication function, and more particularly to a task management system utilizing the chat function for mobile terminals.

### BACKGROUND ART

In order to smoothly carry out the business in workplaces of a certain scale such as retail stores, event sites, accommodation facilities, restaurants and workshops, it is required that the staff members (operators or workers) share information and act cooperatively. For example, when guiding or escorting guests, notifying the status of congestion in a certain area of workplace, notifying the state of progress of events or works and handling troubles, it is necessary that the staff members share various kinds of information precisely and promptly and that instructions of the tasks, reports of the status of ongoing tasks and confirmation of completion of tasks are carried out in a timely and appropriate manner.

Conventionally used in such workplaces are transceivers which enable oral communication. Staff members and directors each carries a transceiver on his/her person to communicate, give and get instructions, report and consult with one another. Communication using transceivers is advantageous in that it is real time and simultaneous.

Along with the prevalence of mobile terminals and with the development of communication infrastructure in recent years, mobile terminals, in place of transceivers, came into use for communication. Such functions as email, text message, message board, chat, group call and the like has made it possible for users to communicate with others real time and simultaneously. It is further advantage of using mobile terminals that the information exchanged can be stored as text data or audio data which can be later reproduced—an advantage that transceivers does not have.

As an example of the above, Patent Document 1 discloses a cooperative task management system using an SNS (Social Networking Service). In this system, implementation of the tasks are prompted by workers posting a message regarding a task on a message board of the SNS and the system encouraging the other workers to post a response to the message.

Patent Document 2 discloses a work flow management system in which, using a groupware, an email is sent to multiple candidates requesting to undertake a task and assigning the task to one of the candidates.

### PRIOR ART DOCUMENT

### Patent Document

Patent Document 1: Japanese Patent Laid-open No. 2009-187044.

Patent Document 2: Japanese Patent Laid-open No. 2001-319183.

### DISCLOSURE OF THE INVENTION

### Problems to be Solved by the Invention

In addition to the above, it is possible to share the tasks using a group chat function. A group chat function allows multiple users to share a common display area on which texts and images are posted so as to share the information among the group of users. This group chat function enables the users to give and get with one another information, instructions, reports and consultations regarding tasks to be shared among the users or tasks to be handled cooperatively.

FIG. 14 is a view showing an example of a display screen where tasks are shared by means of a group chat function. In this example, A and C has a one-to-one communication successfully. The user of this mobile terminal has posted a one-to-many message that calls for attention of unspecified users, to which D has responded. Similarly, B has posted a one-to-many message, to which nobody has yet responded.

In this chat screen, posts are displayed from top to bottom in chronological order, and older posts are scrolled up and out of the screen as new posts are entered one after another. The users can scroll the screen back to see the older posts.

As shown in the above, on the screen of a group chat among multiple users are disorderly displayed one-to-one message posts and one-to-many message posts in chronological order. This often causes such situations where talks by different parties get entangled, and a post is scrolled out of the screen before its message is delivered, the message thereafter left unaddressed. The only way to avoid such situations is to encourage each user to continually and carefully check the older posts by scrolling the screen back. Another problem with sharing and managing tasks using the group chat function is that it is not easy to understand and even easy to misunderstand whether or not the tasks have been formally undertaken, who is in charge of the tasks, how the tasks are being handled at the moment, whether or not there is any problem with the tasks and whether or not the tasks have been completed even though these information is important in cooperatively handling the tasks.

The underlying cause of the above problem is that, with the widespread use and development of electronic communication devices, the amount of exchanged information has become too excessive for users to perceive or handle. Nonetheless, in order not to stagnate business, users have to bare the burden of promptly picking out information which is concerned to themselves and handling it.

On the other hand, in communication using transceivers as described in the above, the amount of exchanged information does not increase. There are, however, such problems that messages tend to be left unresponded as information is transferred only in an unilateral way from a sender to a receiver, that there is no means of storing exchanged information and that it is troublesome for users to carry multiple transceivers to implement tasks such as serving for customers while receiving instruction with ears.

The cooperative task management system disclosed in Patent Document 1 enables to inform multiple staff members of tasks by posting messages regarding the tasks on a message board of an SNS, but it does not go as far as assigning each task to particular staff member(s). Thus, the system fails to enable users to share information as to how the tasks are being handled at the moment, whether or not there is any problem with the tasks and whether or not the tasks have been completed.

The work flow management system disclosed in Patent Document 2 enables to inform multiple candidates of tasks generated in a groupware to prompt the candidates to voluntarily undertake the tasks by sending return emails. Since the system defines a task as that assigned to and handled by a single staff member, which does not require cooperation with other staff members, the system does not go as far as enabling to share information as to whom the tasks are assigned to, how the tasks are being handled at the moment and whether or not the tasks have been completed.

In consideration of the above problems of the prior art systems, it is an object of the present invention to provide a task management system for assigning tasks to multiple staff members and managing tasks in which information as to the assignment, current status, completion, etc. of tasks can be shared among the staff members so as to encourage the staff members to work cooperatively and to ensure each staff member to receive information only which is concerned to themselves.

### Means for Solving the Problems

As a result of earnest study in consideration of the above problems, the present inventors have come up with an idea of a chat system in which each task is represented as a discrete “task cue” and the staff can share information of the task cue being undertaken, handled and completed and also in which a chat function is provided which allows the staff to exchange information regarding each task cue. Such a system enables the staff to explicitly convey information as to the assignment, current status, completion, etc. of tasks and to promote cooperation among the staff. Thus, the present invention has been accomplished.

According to the present invention, there is provided a task management system using mobile terminals comprising: a means of generating on a mobile terminal a task cue including information of instruction on a task; a means of sending said task cue to a selected group of mobile terminals such that said task cue is displayed thereon; a means of receiving input of information, in at least one of the mobile terminals having received said task cue, that the user of the mobile terminal has undertaken the task cue; a means of allowing to exchange information among the mobile terminals undertaking the same task cue; a means of receiving input of information, in the mobile terminals having generated the task cue or undertaking the task cue, that the task cue has been completed; a means of notifying the mobile terminals of the progress and completion of the task cue; wherein the completed task cue is not displayed on the mobile terminals.

The task management system using mobile terminals according to the present invention is also characterized in that said task cue includes information of area in which the task is implemented and said task cue is sent to and displayed on the mobile terminals present in the area or whose users are allocated to the area.

This enables to allocate each task to a particular area.

The task management system using mobile terminals according to the present invention is also characterized in that said task cue includes information of the group of users assigned with the task and said task cue is sent to and displayed on the mobile terminals whose users belong to the group assigned with the task.

This enables to assign each task to a particular group of users.

The task management system using mobile terminals according to the present invention is also characterized in that said task cue includes information of required authority or competence to implement the task and said task cue is sent to and displayed on the mobile terminals whose users have the required authority or competence.

This enables to assign each task to those who have appropriate authority or competence.

The task management system using mobile terminals according to the present invention is also characterized in that said task cue includes information of degree of urgency of the task and said task cue is displayed on the mobile terminals along with the degree of urgency of the task.

This enables to get urgent tasks to be handled with priority.

The task management system using mobile terminals according to the present invention further comprises a means of receiving input of information, on the mobile terminals having generated and sent the task cue, of changes of the area in which the task is implemented, the group of users to be assigned with the task, the authority of the users, the competency of the users or the degree of urgency of the task.

This enables to update the information of the status of the tasks in real time so as to improve efficiency of the tasks and to enhance cooperation.

The task management system using mobile terminals according to the present invention is also characterized in that said means of allowing to exchange information among the mobile terminals undertaking the same task cue allows the mobile terminals to send and receive texts, images, videos, voices or location information in a chat format.

By providing a discrete chat for each task cue, it is possible to prevent situations where communication regarding different tasks get entangled.

The task management system using mobile terminals according to the present invention further comprises a means of obtaining information as to how said task cue is handled by each mobile terminal and analyzing the performance of each mobile terminal in implementing the task.

This enables to, in real time or posteriori, confirm the performance of the tasks, pick up the problems and consider the countermeasures.

The task management system using mobile terminals according to the present invention further comprises a means of obtaining information as to how said task cue is handled by each mobile terminal and analyzing the performance in each area where the task is handled.

This enables to comprehend the tendency and problems of each area.

The task management system using mobile terminals according to the present invention further comprises a means of obtaining information as to how said task cue is handled by each mobile terminal and analyzing the performance of each group of users in implementing the task.

This enables to comprehend the tendency and problems of each group of users.

The task management system using mobile terminals according to the present invention further comprises a means of detecting the status of congestion in each area where the task is handled and a means of notifying the mobile terminals present in the area or whose users are allocated to the area of the status of congestion.

This enables to allocate the tasks in consideration of the detected status of congestion in real time and to analyze the correlation between the status of congestion and the performance of the tasks.

The task management system using mobile terminals according to the present invention further comprising map data of places where the tasks are handled, wherein information of areas included in said task cue and/or exchanged among the mobile terminals is based on said map data.

For example, by indicating a pin on the map as shown in FIGS. 7 and 8, the users can exchange information in an understandable way.

### Effects of the Invention

As described in the above, the present invention provides a chat-base task management system in which each task is represented as a discrete “task cue” and the staff members can share information of task cues being undertaken, handled and completed and also in which a chat function is provided which allows staff members to exchange information regarding each task cue.

In the system, each staff members is shown only the task cues that is related to him or her at the moment and completed task cues are not shown such that the important task cues are not lost even in a massive flow of tasks cues. Thus, the system contributes to reduce the burden of staff members and improve work efficiency.

### BRIEF DESCRIPTION OF THE DRAWINGS

FIG. 1 is a schematic view showing an exemplary configuration of a chat-base task management system according to the present invention.

FIG. 2 is a schematic view showing an exemplary configuration of the task management server shown in FIG. 1.

FIG. 3 is a schematic view of an exemplary configuration of user data.

FIG. 4 is a schematic view of an exemplary configuration of task data.

FIG. 5 is a schematic view showing an exemplary configuration of one of the mobile terminals shown in FIG. 1.

FIG. 6 is a view showing a top screen displayed on a user's mobile terminal.

FIG. 7 is a view showing a screen representing task cue details.

FIG. 8 is a view showing a task cue handling screen.

FIG. 9 is a view showing an example of task analysis display screen for analyzing a task in the system.

FIG. 10 is a view showing an example of task analysis display screen for analyzing a task in the system.

FIG. 11 is a view showing an example of task analysis display screen for analyzing a task in the system.

FIG. 12 is a schematic view showing another exemplary configuration of one of the mobile terminals shown in FIG. 1.

FIG. 13 is a schematic view showing another exemplary configuration of the task management server shown in FIG. 1.

FIG. 14 is a view showing an example of a display screen where tasks are shared by means of group chat function.

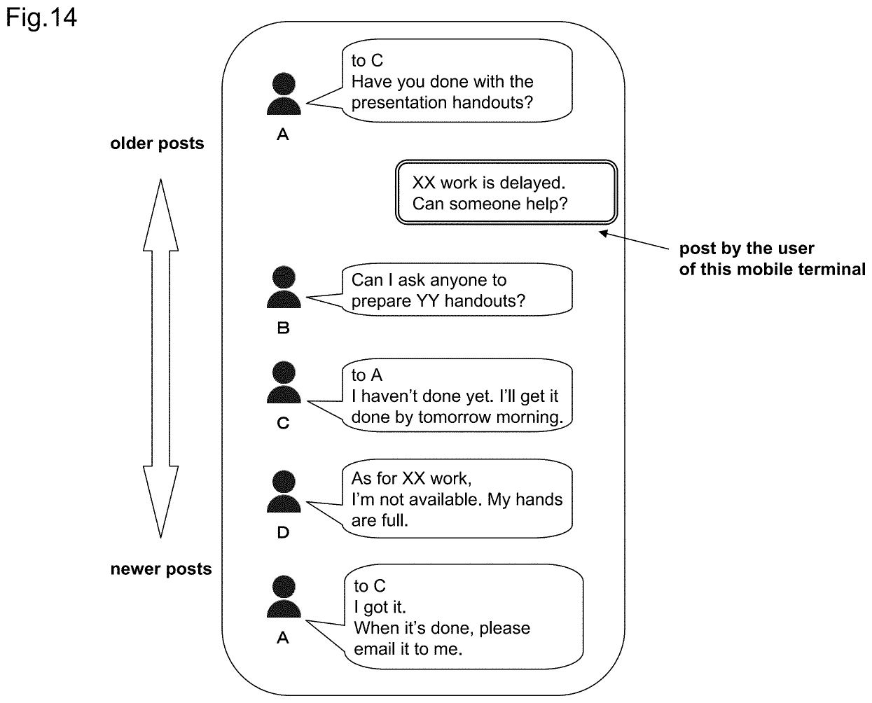

### BEST MODE FOR CARRYING OUT THE INVENTION

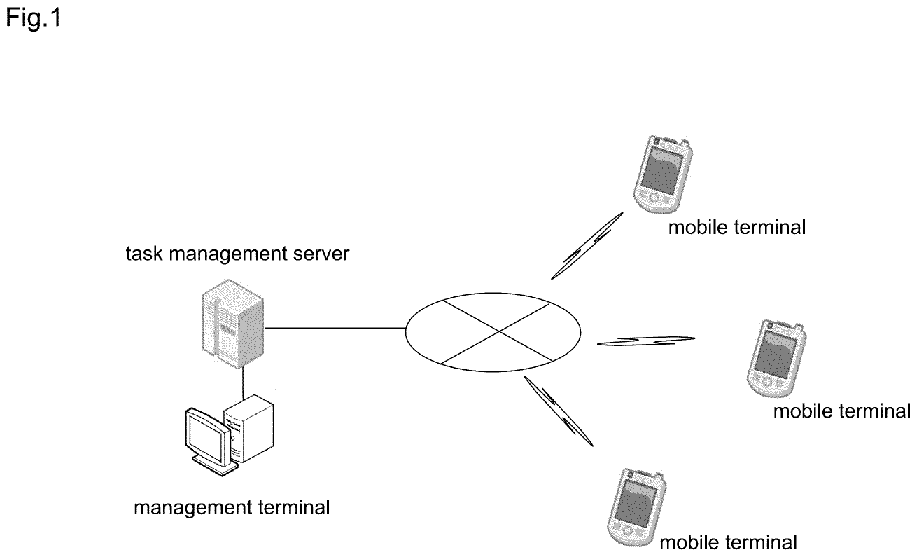

Described hereinafter in detail with reference to the attached figures are the best mode for carrying out a chat-base task management system according to the present invention. In the FIGS. 1 to 13 illustrating exemplary embodiments of the present invention, like reference numerals refer to like members which have similar basic composition and operation.

### System Configuration

FIG. 1 is a schematic view showing an exemplary configuration of a chat-base task management system according to the present invention.

As shown in FIG. 1, the system is constructed by a software-based interaction of a task management server managing generation, progress and completion of tasks and mobile terminals carried by users (or staff members in charge of tasks; the same shall apply hereinafter), the task management server and the mobile terminals being capable of communicating one another.

The mobile terminals are such devices as smartphones, mobile phones, tablet PCs and wearable terminals capable of implementing softwares to run the system. In place of the mobile terminals, (laptop or desktop) PC terminals equipped with wireless communication functions may be employed.

An administrator of the system can operate the task management server using a management terminal.

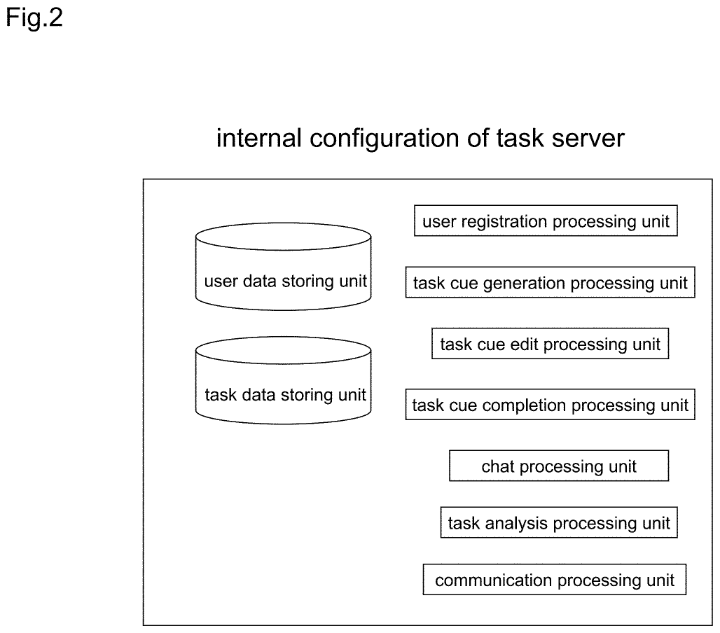

FIG. 2 is a schematic view showing an exemplary configuration of the task management server shown in FIG. 1.

In FIG. 2, the task management server comprises a user data storing unit, a task data storing unit, a user registration processing unit, a task cue generation processing unit, a task cue edit processing unit, a task cue completion processing unit, a chat processing unit, a task analysis processing unit and a communication processing unit.

The user data storing unit stores such user information as user account, belonging group, business in charge, responsible area, skills, authority, attendance and conditions for undertaking and implementing tasks (e.g. personnel evaluation).

The user account information identifies users ho use the system. In case each user is provided with his/her own mobile terminal, the account information may identify the mobile terminal of each user. The information of belonging group identifies workgroup(s) to which users belong. The information of business in charge identifies the business(es) or work(s) which users are in charge of. A user may belong to multiple workgroups and/or be in charge of multiple businesses or works. The information of responsible area identifies the areas allocated to users each of which is part of the entire area where tasks are implemented. The information of skills identifies users' skills, qualifications, etc. relevant to the businesses or works. The information of authority identifies users' authority, position, scope of responsibility, etc. The information of attendance identifies users' status such as active, idle and unavailable.

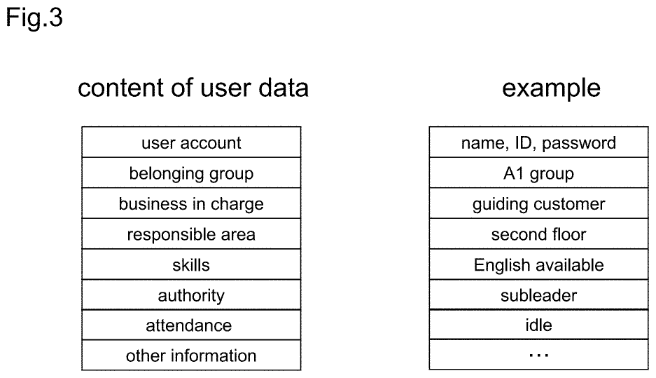

FIG. 3 is a schematic view of an exemplary configuration of user data

The task data storing unit stores such information as identifiers, attributes, contents, associated chats of tasks and conditions for assigning/allocating and implementing tasks.

The task identifier information identifies each task generated and implemented in the system. Since each task is treated as a discreet “task cue”, the task identifier information typically includes task cue ID and the like. The attribute information identifies generators, time of generation, time of assignment, time of completion, types of tasks, areas or locations to which tasks are allocated, groups concerned, required authority, required skills, users currently assigned with the task cues, status of the task cues (not yet undertaken, undertaken and handled, completed, etc.), urgency and the like. The information of content of tasks includes what users have inputted, typically in forms of a text, an image, a movie, a voice, a hyperlink and the like. The information of a chat associated with each task cue includes texts, images, movies, voices, hyperlinks and the like which are posted by users.

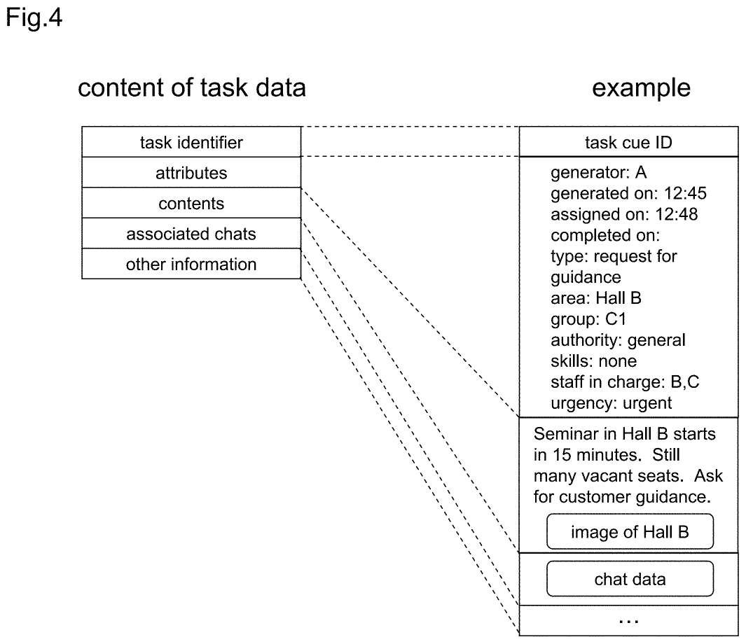

FIG. 4 is a schematic view of an exemplary configuration of task data

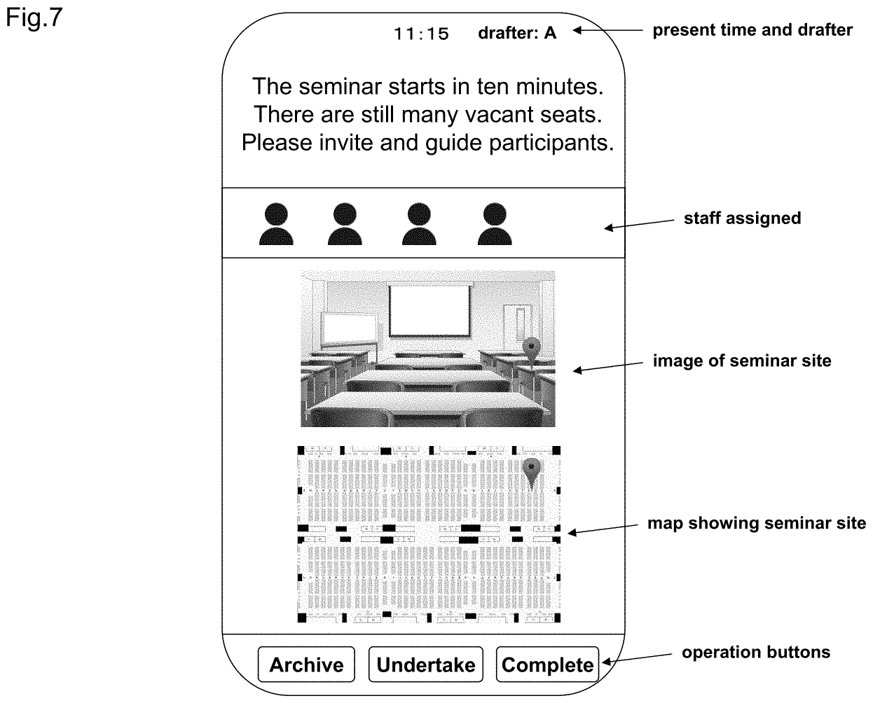

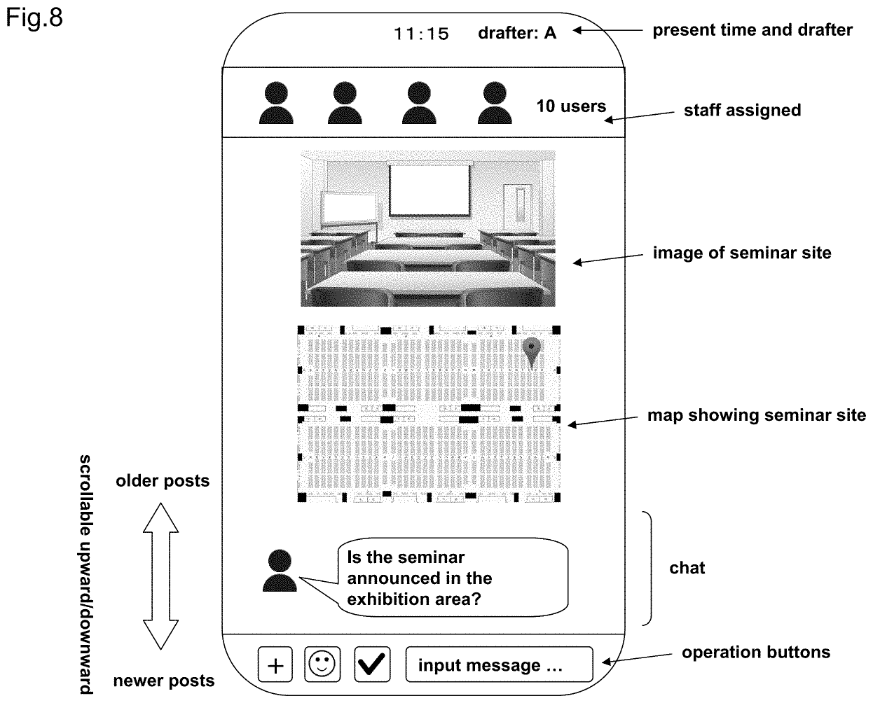

In addition, the task data storing unit preferably stores map data of the places or buildings where tasks are to be implemented. This allows users to exchange information of the locations where tasks are to be implemented and where equipments and goods are situated using the location information and the maps. For example, showing a pin on a particular spot on a map as shown in the examples of display screens in FIG. 7 and FIG. 8, will allow users to exchange information of locations plainly and clearly.

The user registration processing unit receives input of entry, change and deletion of user information stored in the user data storing unit. Such an operation may be implemented by a system administrator using the management terminal or by users using their mobile terminals. The input may be voice input.

The task cue generation processing unit receives input of generation of a task cue by the operation of a user on a mobile terminal. The user inputs attribute information of task such as type, area, group in charge, required authority, required skill, urgency and content of the task. In doing this, a list of users, groups and areas may be shown so as to allow the user to select from the list of users, groups and areas to be related to the task cue. When showing a list of users, it is preferable to show only the users who are available based on the attendance information. The task cue generation processing unit generates a task cue by adding other necessary information to the above inputted information. The generation of a task cue may be implemented by a system administrator using the management terminal. The input may be voice input.

The generated task cue is stored in the task data storing unit and broadcast to the related mobile terminals.

The task cue edit processing unit receives input of editing of a task cue by the operation of a user on a mobile terminal or of a system administrator using the management terminal. The information of editing of task cues is stored in the task data storing unit and broadcast to mobile terminals related to the task cue.

The task cue completion processing unit receives input of completion of a task cue by the operation of a user on a mobile terminal or of s system administrator using the management terminal. Preferably, it is only those who generated the task cue, handled the task cue and are responsible for the task cue as well as the system administrator that are authorized to make the task cue completed. The information of completion of the task cue is stored in the task data storing unit and broadcast to the mobile terminals related to the task cue. The completed task cues, which no one has to take care of, are no longer shown on the display screen of users' mobile terminals.

The chat processing unit receives input of posts to a chat associated with a task cue and displays a chat on mobile terminals related to the task cue which is associated with the chat. An example of a chat display screen is shown in FIG. 7.

The task analysis processing unit implements various kinds of analysis on information of the ongoing and completed task cues and outputs results of the analysis. It enables to show progress of the tasks and users' actions in each area or of each team and to provide a comparative study of performance of users and teams. For such task analyses, conventional analytical methods can be employed. It also enables to cope with a task which is ongoing but making poor progress by giving an alert, setting a higher degree of urgency to the relevant task cues and dispatching additional staff members.

The above-described storing units and processing units are attained by the cooperation of the hardware resources of the task management server and the software resources constructed thereon.

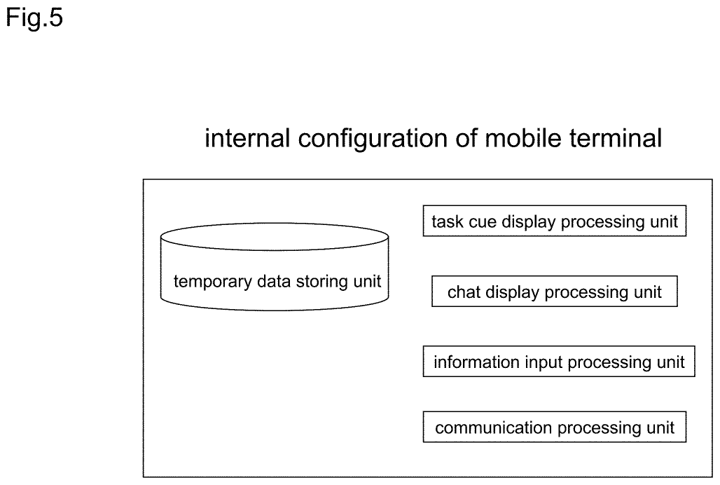

FIG. 5 is a schematic view showing an exemplary configuration of one of the mobile terminals shown in FIG. 1.

In FIG. 5, the mobile terminal comprises a task cue display processing unit, a temporary data storing unit, a chat display processing unit, an information input processing unit and a communication processing unit.

The temporary data storing unit temporarily stores various kinds of data handled and processed in the system operating on the mobile terminal.

The task cue display processing unit, upon receiving a task cue from the task management server, displays the task cue in a format according to its attribute on the display screen of the mobile terminal. When receiving an update information of the task cue from the task management server, the task cue display processing unit timely updates the displayed content on the display screen of the mobile terminal.

The chat display processing unit displays a chat based on the chat data included in the task cue in a predetermined format on the display screen of the mobile terminal.

The information input processing unit, upon receiving input of operation to the task cue or the chat by a user, performs predetermined processes, such as displaying the task cue and the chat, allowing the user to undertake the task cue, completing of the task cue, editing the task cue and posting on the chat. The input may be voice input.

The above-described storing units and processing units are attained by the cooperation of the hardware resources of the mobile terminal and the software resources constructed thereon.

### System Operation

Described hereinafter with reference to the display screen on a mobile terminal (e.g. smartphone) of a user is the operation of the above-described chat-base task management system.

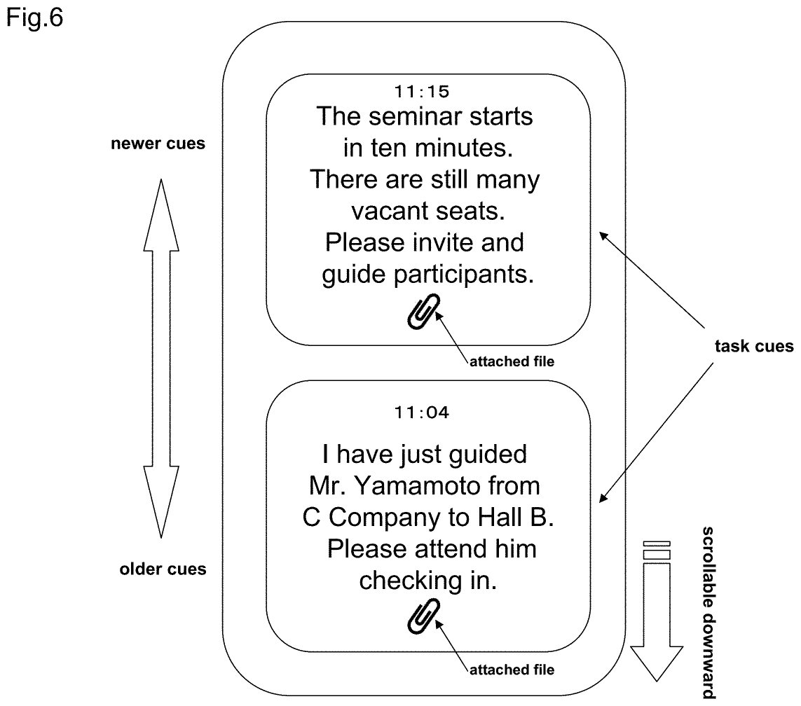

FIG. 6 is a view showing a top screen (or task cue list display screen) displayed on a user's mobile terminal.

On the display screen are displayed two task cues. Each task cue includes such information as drafted time, texts and presence/absence of attached files. Newer task cues are displayed on the upper side and older task cues on the lower side. It is possible to scroll down the screen and get the scrolled out task cues back on the screen. The task cues are displayed in different colors according to their status, e.g. unundertaken, undertaken, urgent, etc. On this display screen, all the task cues which have been drafted and not yet completed (excluding those archived) can be displayed.

Upon user's selecting (tapping) a task cue, the task cue details are displayed on the screen as shown in FIG. 7.

Displayed on this screen are text information, attached images, etc. relating to the task, the icons of the staff assigned with the task and the number of staff members assigned with the task. Other details may be displayed upon user's operation using the operation buttons at the bottom of the screen. The operation button “Archive” is for hiding the task cue from the screen. The operation button “Complete” is for changing the task cue into the state of completion.

Upon user's tapping the operation button “Undertake” on the screen displaying the task cue details, a task cue handling screen is displayed as shown in FIG. 8.

Displayed on this screen are the task cue details same as those shown in FIG. 7, a chat among the users and operation buttons used for the chat. The user can input texts and images onto the chat and completion of the task cue.

As described in the above, the chat-base task management system according to the present invention enables to manage the tasks by allowing users to select and undertake one or more of the task cues on the list, to handle the task cue while timely exchanging information, giving and getting instructions, reporting and consulting with other users in charge of the same task cue and to complete the task cues.

The system may have an additional function to display information of task cues and their status as needed by users. Examples of such information are a list of task cues archived and a list of task cues completed. By utilizing the hardware functions of the smartphone, it is possible to enable the users to enjoy intuitive operation. For example, on a task cue list display screen, a user may archive a task cue by swiping it right and complete it by swiping it left.

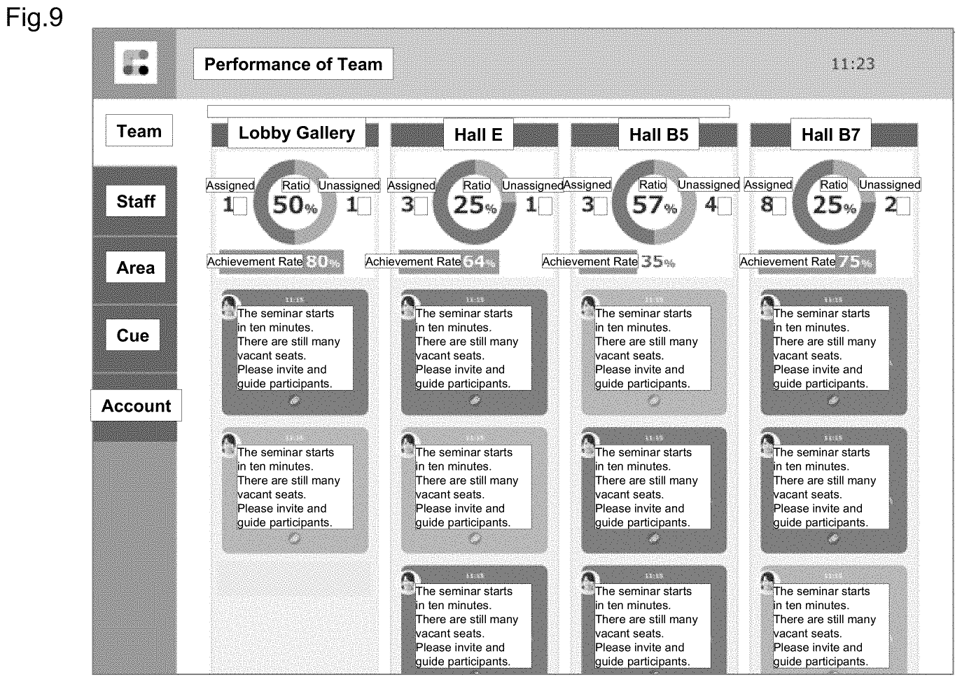

FIGS. 9 to 11 show examples of task analysis display screens for analyzing tasks in the system.

These task analysis display screens are displayed on the management terminal or the mobile terminals of users with certain authority (e.g. general managers, area managers, etc.).

The task analysis display screen shown in FIG. 9 represents performance of each team. Shown in the display screen are assignment ratios (number of tasks assigned to team/number of tasks drafted for team) of each team, achievement ratios (number of tasks completed by team/number of tasks drafted for team) of each team, a list of task cues to be currently handled by each team and so on. On this display screen, an operator may select a particular task cue to see the details.

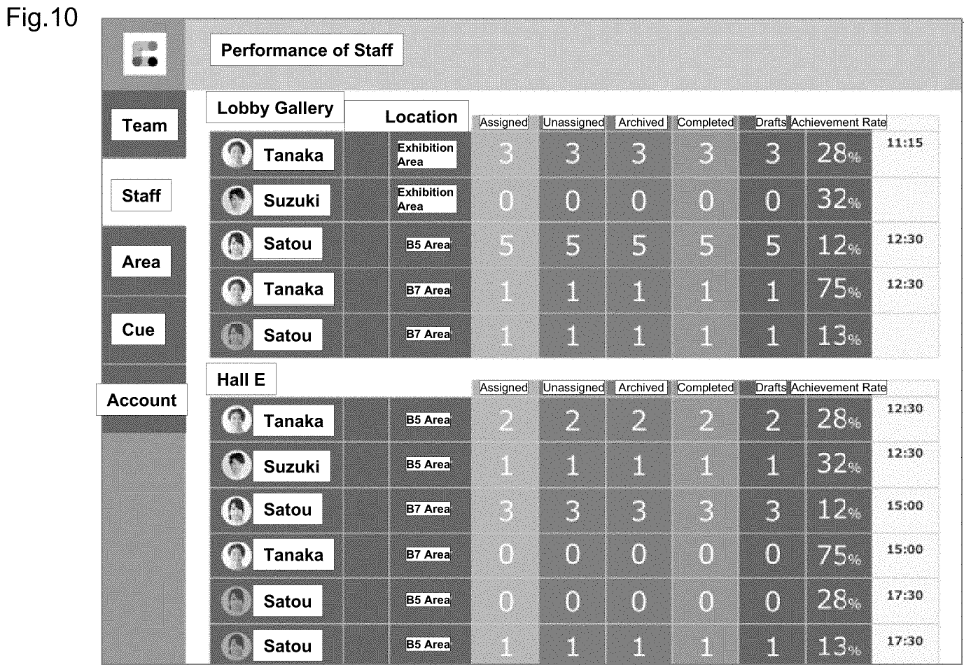

The task analysis display screen shown in FIG. 10 represents performance of each staff member. Shown in the display screen are, for each staff member, number of tasks assigned with, achievement ratio (number of tasks completed/number of tasks drafted for team or staff member) and the like. On this display screen, an operator may select a particular staff member to see the details.

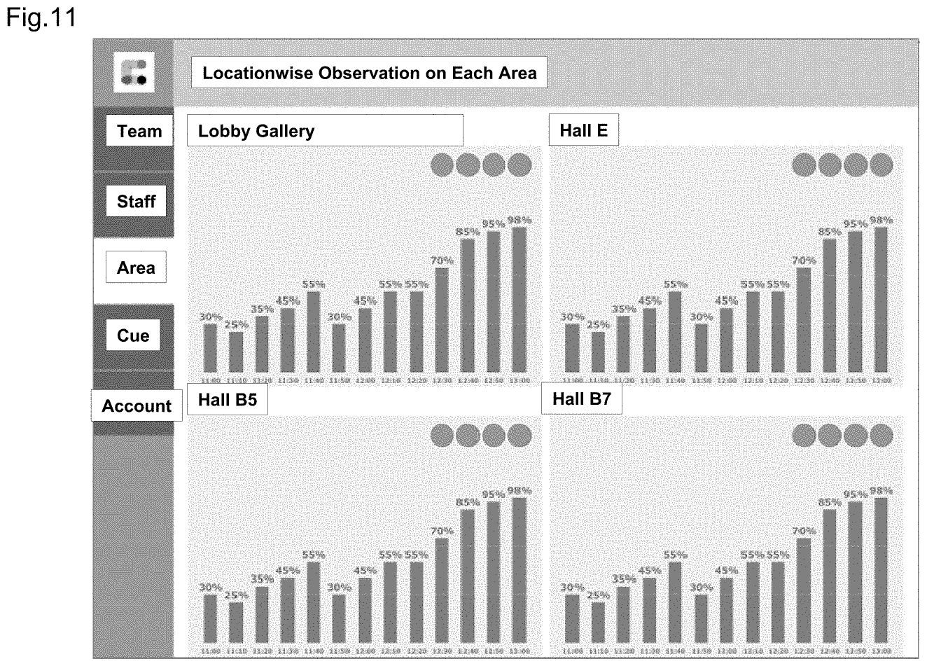

The task analysis display screen shown in FIG. 11 represents status and transition of congestion in each area. Shown in the display screen is the status of congestion in each area in each time zone. The system obtains information of the status of congestion from external devices or systems connected to the system (as described bellow).

These log data may be outputted in a CSV format thereby enabling to automatically generate a daily and monthly report of each staff member and team.

With the use of the above-described chat function of the system, it is possible to;

get a real time perspective on the status of the ongoing tasks and redistribute the human resources so as to make up for the behindhand areas and tasks,

perform a real time analysis on the behindhand tasks and the activities of the staff, clarify the cause and cope with it by redistributing the human resources,

perform an ex post analysis to clarify the cause and problems and perform personnel evaluation and accumulate the cases.

### Alternative Configuration

In the chat-base task management system according to the present invention, the task management server and the mobile terminals may be configured in different ways from which described in the above.

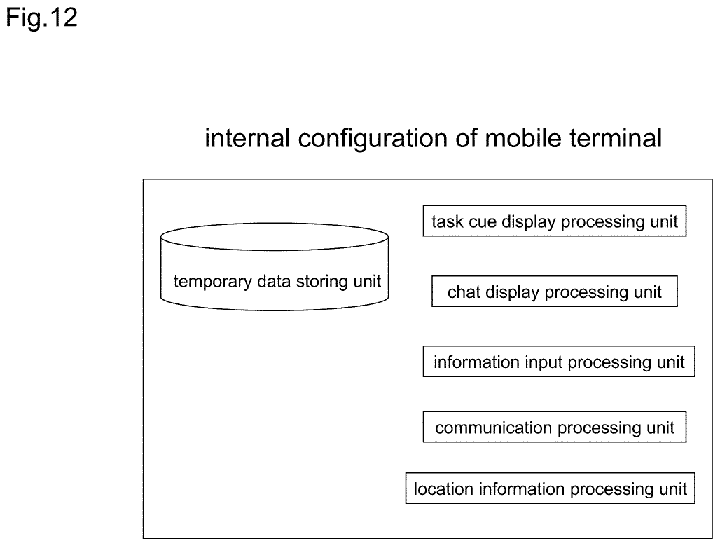

FIG. 12 is a schematic view showing another exemplary configuration of one of the mobile terminals.

In FIG. 12, the mobile terminal further comprises a location information processing unit in addition to the configuration shown in FIG. 5.

The location information processing unit, utilizing a GPS function of the mobile terminal or an beacon service via external wireless access points (for example,

http://www.zyyx.jp/service/solution/ibeacon.html), obtains location information of the mobile terminal and sends it to the task management server.

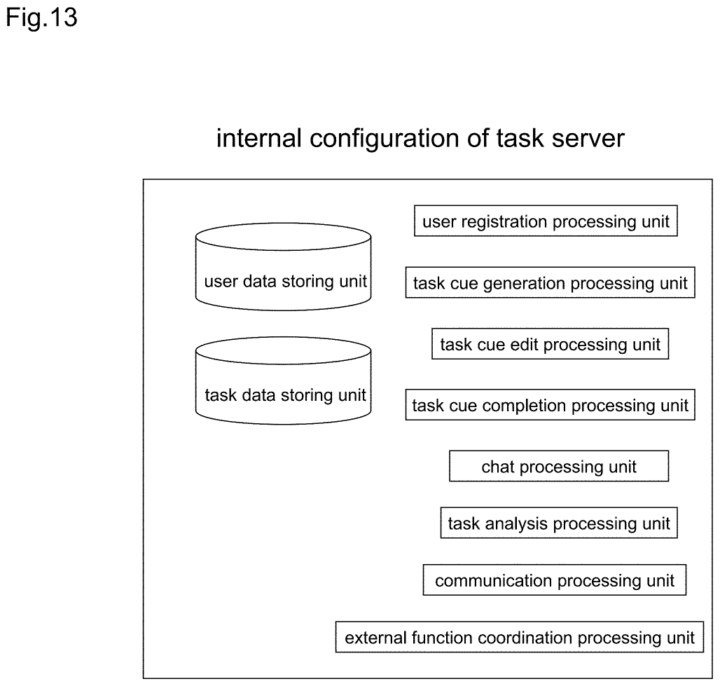

FIG. 13 is a schematic view showing another exemplary configuration of the task management server.

In FIG. 13, the task management server further comprises an external function coordination processing unit in addition to the configuration shown in FIG. 2.

The external function coordination processing unit coordinates with external devices, systems, etc. to obtain information for use in the system.

It may coordinate with the location information processing unit of the mobile terminal shown in FIG. 12 to enable the system to obtain location information of a user (of a mobile terminal which the user carries, to be precise) in real time and dynamically assign task cues. Task cues may be sent to the mobile terminals placed in particular areas regardless of the belonging groups or allocated areas of users. Alternatively, the system may organize a temporary group of users in a particular area to assign task cues. Thus, task cues can be handled dynamically and in real time.

The system may have such a function that dynamically allocates task cues according to the status of congestion in each area which is obtained in real time by coordinating with external congestion sensing means located throughout the workplace. With such function, it is possible to encourage users of a group which has spare human resource to temporarily undertake task cues in the state of congestion. It is also possible to send notices to the users' mobile terminals to notify users of the congestion in each area.

As a means of sensing congestion, the system can employ video cameras and image analyzing software (for example, http://www.arobaview.com) or other prior art techniques.

### Mode of Use

The chat-base task management system according the present invention can be used in such situations as event sites, amusement facilities, accommodation facilities, retail stores, restaurants and workshops where staff members are required to share information and cooperate. Since tasks to be handled at the moment get to be apparent in the form of task cues, staff members (users) can exchange information, give and get instructions, report and consult with one another using their own mobile terminals so as to handle the tasks cues efficiently.

Although embodiments and examples of the chat-base task management system according the present invention are described in the above, no limitation of the scope of the present invention is thereby intended. Those skilled in the art would contemplate various alterations and modifications on the structures and functions of the task management server, the hardwares and softwares on the mobile terminals within the scope of the present invention.

For example, the chat-base task management system according the present invention can be packaged into an existing groupware or an existing SNS system as an additional function.

Although the above-described chat-base task management system is configured to be centered on the task management server, the system may employ a cloud type configuration in which multiple servers constitute a virtual task management server. Alternatively, the system can do away with the task management server in case it is constituted solely by the functions of softwares installed in the mobile terminals.

### INDUSTRIAL APPLICABILITY

As shown in FIGS. 1 to 5, 12 and 13, the chat-base task management system according to the present invention is attained by the operations of the OS, application software, databases, network systems and the like which are constructed on the hardware resources of computers comprising CPUs, memories, auxiliary storage devices, display devices, I/O devices and the like. The system performs, using the above hardware resources, information processing of generating, assigning/undertaking, completing and showing the status of a task cue. The present invention, as such, constitutes a creation of technical ideas utilizing a law of nature, which can be utilized in the filed of software, information communication and the like.

1. A task management system using mobile terminals comprising:
a means of generating on a mobile terminal a task cue including information of instruction on a task;
a means of sending said task cue to a selected group of mobile terminals such that said task cue is displayed thereon;
a means of receiving input of information, in at least one of the mobile terminals having received said task cue, that the user of the mobile terminal has undertaken the task cue;
a means of allowing to exchange information among the mobile terminals undertaking the same task cue;
a means of receiving input of information, in the mobile terminals having generated the task cue or undertaking the task cue, that the task cue has been completed;
a means of notifying the mobile terminals of the progress and completion of the task cue;
wherein the completed task cue is not displayed on the mobile terminals.

2. The task management system using mobile terminals as set forth in claim 1, wherein said task cue includes information of area in which the task is implemented and said task cue is sent to and displayed on the mobile terminals present in the area or whose users are allocated to the area.

3. The task management system using mobile terminals as set forth in claim 1, wherein said task cue includes information of group of users assigned with the task and said task cue is sent to and displayed on the mobile terminals whose users belong to the group assigned with the task.

4. The task management system using mobile terminals as set forth in claim 1, wherein said task cue includes information of required authority or competence to implement the task and said task cue is sent to and displayed on the mobile terminals whose users have the required authority or competence.

5. The task management system using mobile terminals as set forth in claim 1, wherein said task cue includes information of degree of urgency of the task and said task cue is displayed on the mobile terminals along with the degree of urgency of the task.

6. The task management system using mobile terminals as set forth in claim 1, further comprising a means of receiving input of information, on the mobile terminals having generated and sent the task cue, of changes of the area in which the task is implemented, the group of users to be assigned with the task, the authority of the users, the competency of the users or the degree of urgency of the task.

7. The task management system using mobile terminals as set forth in claim 1, wherein said means of allowing to exchange information among the mobile terminals undertaking the same task cue allows the mobile terminals to send and receive texts, images, videos, voices or location information in a chat format.

8. The task management system using mobile terminals as set forth in claim 1, further comprising a means of obtaining information as to how said task cue is handled by each mobile terminal and analyzing the performance of each mobile terminal in implementing the task.

9. The task management system using mobile terminals as set forth in claim 2, further comprising a means of obtaining information as to how said task cue is handled by each mobile terminal and analyzing the performance in each area where the task is handled.

10. The task management system using mobile terminals as set forth in claim 3, further comprising a means of obtaining information as to how said task cue is handled by each mobile terminal and analyzing the performance of each group of users in implementing the task.

11. The task management system using mobile terminals as set forth in claim 1, further comprising a means of detecting the status of congestion in each area where the task is handled and a means of notifying the mobile terminals present in the area or whose users are allocated to the area of the status of congestion.

12. The task management system using mobile terminals as set forth in claim 2, further comprising map data of places where the tasks are handled, wherein information of areas included in said task cue and/or exchanged among the mobile terminals is based on said map data.
